(19) United States
(12) Patent Application Publication
(10) Pub. No.: US 2026/0326915 A1
(43) Pub. Date: Oct. 22, 2026

(54) FUEL SUPPLY SYSTEM FOR AN AIRCRAFT PROPULSION SYSTEM

(71) Applicant: Airbus Operations SAS, TOULOUSE (FR)

(72) Inventors: Guillaume RAVENEAU, TOULOUSE (FR); Mathieu BELLEVILLE, TOULOUSE (FR)

(21) Appl. No.: 19/649,706

(22) Filed: Apr. 16, 2026

(30) Foreign Application Priority Data
Apr. 17, 2025 (FR) FR2504113

(51) Int. Cl. B64D 37/30; B64D 37/34

(52) U.S. Cl. CPC B64D 37/30; B64D 37/34

(57) ABSTRACT

A system for supplying fuel to a propulsion system for an aircraft, having, in succession and fluidically connected, a cryogenic tank containing molecular hydrogen in the liquid state, a low-pressure pump, a high-pressure pump, a heat exchanger, a nonreturn valve, a buffer tank intended to contain molecular hydrogen in the gaseous state, a flow-regulating valve, a combustion chamber, and a recirculation circuit connecting the low-pressure pump and the tank. The system uses hydrogen for cooling the fuel supply system. Also an aircraft with such a system.

### CROSS-REFERENCES TO RELATED APPLICATIONS

This application claims the benefit of French Patent Application Number FR 2504113, filed on Apr. 17, 2025, the entire disclosure of which is incorporated herein by way of reference.

### FIELD OF THE INVENTION

The present invention relates to a system for supplying fuel to a propulsion system comprising a combustion engine supplied with molecular hydrogen. The invention also relates to a propulsion system comprising such a fuel supply system and to an aircraft comprising such a propulsion system. The invention also relates to a method of operation of such a fuel supply system.

### BACKGROUND OF THE INVENTION

In order to reduce the pollution generated by the use of aviation fuel when operating an aircraft, aircraft with engines that run on molecular hydrogen have been developed. More particularly, molecular hydrogen is used to supply a combustion chamber in which the molecular hydrogen is burnt so as to generate motive power and turn the internal combustion engine of the aircraft in order to generate the thrust for the aircraft.

In general, liquid molecular hydrogen is stored in a cryogenic tank before being transported and then injected in its gaseous state into the combustion chamber of the engine.

This liquid molecular hydrogen may also be used in the cooling process for cooling certain elements of the propulsion system. In particular, the liquid molecular hydrogen stored in the cryogenic tank may be used to cool a system that uses fuel, for example for delivering liquid molecular hydrogen to a liquid-hydrogen pump and/or the propulsion system. To do this, the liquid molecular hydrogen circulates in the supply pipes of the fuel supply system so as to absorb the heat energy from these pipes and reduce the temperature thereof. As a result of the heat absorbed, the liquid molecular hydrogen changes state and becomes gaseous. The gaseous molecular hydrogen produced during the cooling process can then be discharged into the atmosphere (for example via a venting system).

However, this solution presents safety risks because the discharge of molecular hydrogen may create flammable conditions if this hydrogen mixes with oxygen, and this is obviously not satisfactory. Specifically, the mixture of oxygen and molecular hydrogen requires only a very small minimal amount of energy to ignite it in a broad range of molecular-hydrogen concentrations (generally of the order of 4 to 74% concentration in air). Immediate or delayed ignition of molecular hydrogen may lead to a flame or to an explosion liable to cause significant damage, either to the propulsion system or even to the aircraft.

Furthermore, such a discharge of molecular hydrogen into the atmosphere has a negative impact on the climate because of the warming effect that such a discharge into the atmosphere presents.

Moreover, this solution is high-cost because a non-negligible quantity of molecular hydrogen is lost in discharges into the atmosphere during the cooling process.

There is therefore a need for a novel solution that enables improvements to be made to the process of cooling an aircraft fuel supply system using molecular hydrogen.

### SUMMARY OF THE INVENTION

An object of the present invention is to propose a fuel supply system that has optimized molecular-hydrogen consumption.

To this end, the invention proposes a system for supplying fuel to a propulsion system for an aircraft, comprising:
a cryogenic tank containing fuel, wherein said fuel is liquid molecular hydrogen, said cryogenic tank comprising a first inlet orifice and a first outlet orifice;
a low-pressure pump situated downstream of said tank, comprising a second inlet orifice fluidically connected to said first outlet orifice of said tank, and a second outlet orifice;
a high-pressure pump situated downstream of said low-pressure pump, comprising a third inlet orifice fluidically connected to said second outlet orifice of said low-pressure pump, and a third outlet orifice;
a heat exchanger situated downstream of said high-pressure pump, comprising a fourth inlet orifice fluidically connected to said third outlet orifice of said high-pressure pump, and a fourth outlet orifice;
a nonreturn valve situated downstream of said heat exchanger, comprising a fifth inlet orifice fluidically connected to said fourth outlet orifice of said heat exchanger, and a fifth outlet orifice;
a buffer tank intended to contain gaseous molecular hydrogen, said buffer tank being situated downstream of said nonreturn valve and comprising a sixth inlet orifice fluidically connected to said fifth outlet orifice of said nonreturn valve, and a sixth outlet orifice;
a flow-regulating valve situated downstream of said buffer tank, comprising a seventh inlet orifice fluidically connected to said sixth outlet orifice of said buffer tank, and a seventh outlet orifice;
a combustion chamber situated downstream of said flow-regulating valve, comprising an eighth inlet orifice fluidically connected to said seventh outlet orifice of said flow-regulating valve; and
a recirculation circuit comprising a ninth inlet orifice fluidically connected to said second outlet orifice of said low-pressure pump, and a ninth outlet orifice fluidically connected to said first inlet orifice of said tank.

Such a system makes it possible to optimize the use of the molecular hydrogen for cooling the fuel supply system. This makes it possible to minimize the amount of molecular hydrogen discharged into the atmosphere during the course of cooling, thus limiting the climate-change impact and the safety risks.

Advantageously, the fuel supply system further comprises a shut-off valve, situated between said heat exchanger and said nonreturn valve, comprising a tenth inlet orifice fluidically connected to said fourth outlet orifice of said heat exchanger, and a tenth outlet orifice fluidically connected to said fifth inlet orifice of said nonreturn valve.

According to one particular aspect of the invention, the fuel supply system further comprises at least a temperature sensor and/or a pressure sensor.

The invention also relates to an aircraft propulsion system comprising a fuel supply system as described hereinabove and to an aircraft comprising at least one such propulsion system.

The invention further relates to a method of operation of a fuel supply system as described hereinabove, wherein the method comprises the steps of:
maintaining the temperature of said low-pressure pump at a temperature below 200 K;
cooling said low-pressure pump by circulating said liquid molecular hydrogen coming from said tank through said low-pressure pump until the temperature of said low-pressure pump is below 30 K;
pressurizing said fuel supply system by injecting said liquid molecular hydrogen from said tank into said system until a pressure within said buffer tank is greater than or equal to 0.1 MPa;
supplying said combustion chamber with molecular hydrogen during the starting and operation of said propulsion system;
cooling said fuel supply system.

According to one particular aspect of the invention, the cooling of the fuel supply system comprises the cooling of the high-pressure pump and of the associated circuitry, so as to attain a state in which the entire fuel supply system has reached its nominal operating state and the aircraft is “ready for take-off”.

According to one particular aspect of the invention, during said steps of cooling said low-pressure pump and of cooling said system, said molecular hydrogen circulating from said tank and passing through said low-pressure pump next circulates in said recirculation circuit in order to return to said tank if the temperature of said molecular hydrogen leaving said low-pressure pump is below 150 K, preferably below 30 K.

According to another particular aspect of the invention, during said steps of cooling said low-pressure pump and of cooling said system, said molecular hydrogen circulating from said tank and passing through said low-pressure pump next circulates in a venting circuit that vents said tank if the temperature of said molecular hydrogen leaving said low-pressure pump is above 30 K, preferably above 150 K.

According to yet another particular aspect of the invention, during said steps of cooling said low-pressure pump and of cooling said system, one fraction of the molecular hydrogen circulating from said tank and passing through said low-pressure pump next circulates in said recirculation circuit in order to return to said tank if the temperature of said molecular hydrogen leaving said low-pressure pump is below 150 K, and one fraction of the molecular hydrogen circulating from said tank and passing through said low-pressure pump next circulates in a venting circuit that vents said tank if the temperature of said molecular hydrogen leaving said low-pressure pump is above 150 K.

According to yet another particular aspect of the invention, during said steps of cooling said low-pressure pump and of cooling said system, one fraction of the molecular hydrogen circulating from said tank and passing through said low-pressure pump next circulates in said recirculation circuit in order to return to said tank if the temperature of said molecular hydrogen leaving said low-pressure pump is below 30 K, and one fraction of the molecular hydrogen circulating from said tank and passing through said low-pressure pump next circulates in a venting circuit that vents said tank if the temperature of said molecular hydrogen leaving said low-pressure pump is above 30 K.

According to another particular aspect of the invention, said step of pressurizing said system comprises a sub-step of maintaining said pressure of the system at a pressure comprised between 0.1 MPa and 5 MPa and during which said flow-regulating valve and said shut-off valve are closed.

This method advantageously makes it possible to cool the high-pressure pump so that it can be used for aircraft take-off. The high-pressure pump is thus switched on at the end of the method, once the system is in the state in which the aircraft is “ready for take-off”, namely once the system has been completely cooled.

### BRIEF DESCRIPTION OF THE DRAWINGS

The aforementioned features of the invention, along with others, will become more apparent on reading the following description of an exemplary embodiment and its variants, said description being given with reference to the appended drawings, in which:

FIG. 1 is a view, from above, of an aircraft according to the invention;

FIG. 2 is a schematic view of a fuel supply system according to the invention; and

FIG. 3 is a diagram schematically illustrating the steps of a method of operation of the fuel supply system of FIG. 2.

### DETAILED DESCRIPTION OF THE PREFERRED EMBODIMENTS

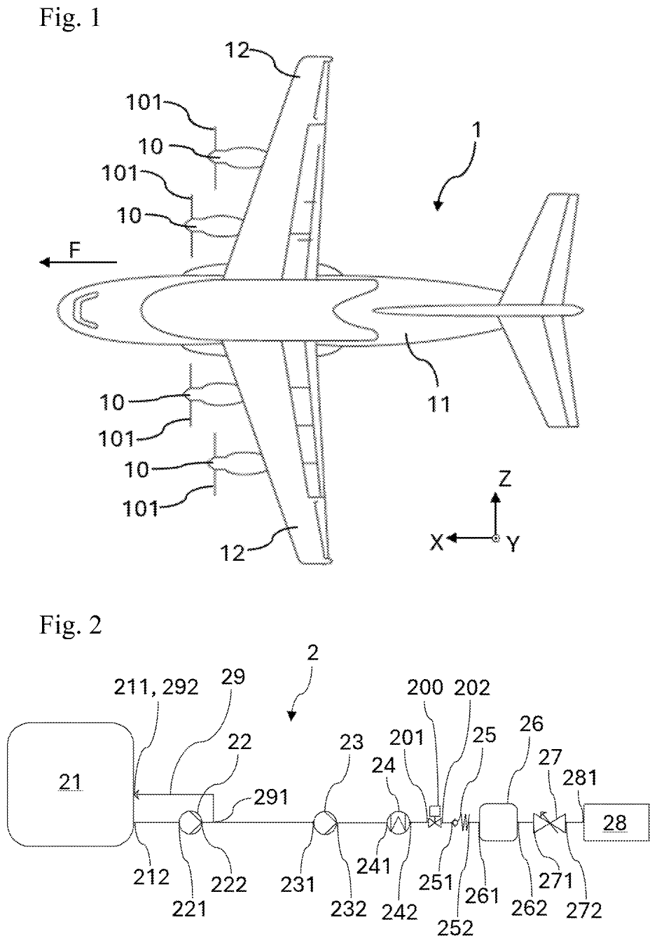

FIG. 1 shows an aircraft 1 that has a fuselage 11 on either side of which is fastened a wing 12. At least one propulsion system 10 according to the invention is fastened beneath each wing 12.

By convention, the X direction is the name given to the longitudinal direction of the aircraft 1, the Y direction is the name given to the transverse direction of the aircraft 1, which direction is horizontal when the aircraft 1 is on the ground, and the Z direction is the name given to the vertical or height direction which is vertical when the aircraft 1 is on the ground, these three directions X, Y and Z being mutually orthogonal.

Moreover, the terms “front” and “rear” should be considered with respect to a direction of forward movement of the aircraft 1 during operation of the propulsion systems 10, this direction being depicted schematically by the arrow F.

In the invention embodiment that is presented here, the propulsion system 10 assumes the form of an internal combustion engine comprising a propeller 101 mounted on the drive shaft of the internal combustion engine that uses molecular hydrogen as its fuel. It will obviously be appreciated that the propulsion system 10 of the invention could also be employed with a turbojet engine.

The propulsion system 10 comprises a fuel supply system 2 illustrated in FIG. 2. In particular, the fuel supply system 2 (hereinafter referred to as “the system”) comprises, in succession (which is to say in series) and fluidically connected:
a cryogenic tank 21 containing fuel, and more specifically in this example molecular hydrogen in the liquid state;
a low-pressure pump 22;
a high-pressure pump 23;
a heat exchanger 24 configured to evaporate the molecular hydrogen and raise it to a predetermined temperature before it is injected into the combustion chamber (the propulsion system being configured to operate at a predetermined hydrogen-injection temperature);
a nonreturn valve 25;
a buffer tank 26 intended to contain molecular hydrogen in the gaseous state;
a flow-regulating valve 27; and
a combustion chamber 28.

The system 2 further comprises a recirculation circuit 29 connecting the outlet of the low-pressure pump 22 and the tank 21.

Such a system 2 makes it possible to optimize the use of the molecular hydrogen for cooling the fuel supply system. In effect, thanks to such a system 2 it is possible to recirculate at least some of the molecular hydrogen used for cooling, thus minimizing the amount of molecular hydrogen discharged into the atmosphere during the course of the cooling. In this way, the impact on climate change and the risks to safety are limited.

In particular, it is important to reduce the pressure fluctuations in the combustion chamber 28. Thus, the nonreturn valve 25 makes it possible to block any backflow of molecular hydrogen if the supply of molecular hydrogen coming from the tank 21 is at a pressure lower than that of the buffer tank 26. In addition, the buffer tank 26 makes it possible to reduce the amplitude of the fluctuations, thanks to the compressibility of the gaseous hydrogen in the buffer tank 26. Finally, the flow-regulating valve 27 makes it possible to reduce still further the fluctuations when the pressure within the buffer tank 26 is higher than the pressure required for starting the engine of the propulsion system 10.

More specifically, the various components of the system 2 are fluidically connected by pipes or hoses. Thus, the cryogenic tank 21 comprises a first inlet orifice 211 and a first outlet orifice 212. The low-pressure pump 22, situated downstream of the tank 21, comprises a second inlet orifice 221 fluidically connected to the first outlet orifice 212 of the tank 21. The low-pressure pump 22 further comprises a second outlet orifice 222. The high-pressure pump 23, situated downstream of the low-pressure pump 22, comprises a third inlet orifice 231 fluidically connected to the second outlet orifice 222 of the low-pressure pump 22. The high-pressure pump 23 further comprises a third outlet orifice 232. The heat exchanger 24, situated downstream of the high-pressure pump 23, comprises a fourth inlet orifice 241 fluidically connected to the third outlet orifice 232 of the high-pressure pump 23. The heat exchanger 24 further comprises a fourth outlet orifice 242. The nonreturn valve 25, situated downstream of the heat exchanger 24, comprises a fifth inlet orifice 251 fluidically connected to the fourth outlet orifice 242 of the heat exchanger 24. The nonreturn valve further comprises a fifth outlet orifice 252. The buffer tank 26, situated downstream of the nonreturn valve 25, comprises a sixth inlet orifice 261 fluidically connected to the fifth outlet orifice 252 of the nonreturn valve 25. The buffer tank 26 further comprises a sixth outlet orifice 262. The flow-regulating valve 27, situated downstream of the buffer tank 26, comprises a seventh inlet orifice 271 fluidically connected to the sixth outlet orifice 262 of the buffer tank 26. The flow-regulating valve 27 also comprises a seventh outlet orifice 272. The combustion chamber 28, situated downstream of the flow-regulating valve 27, comprises an eighth inlet orifice 281 fluidically connected to the seventh outlet orifice 272 of the flow-regulating valve 27. Finally, the recirculation circuit 29 comprises a ninth inlet orifice 291 fluidically connected to the second outlet orifice 222 of the low-pressure pump 22, and a ninth outlet orifice 292 fluidically connected to the first inlet orifice 211 of the tank 21.

In a variant embodiment of the invention, as detailed hereinafter in connection with the description of the method of operation of the system 2, the system 2 may further comprise a shut-off valve 200, situated between the heat exchanger 24 and the nonreturn valve 25. The shut-off valve comprises a tenth inlet orifice 201 fluidically connected to the fourth outlet orifice 242 of the heat exchanger 24, and a tenth outlet orifice 202 fluidically connected to the fifth inlet orifice 251 of the nonreturn valve 25.

This shut-off valve 200 is employed in instances in which fluctuations in the supply of fuel are not compatible with the starting sequence for starting the propulsion system 10 of the aircraft 1 but these fluctuations are compatible with the conditions for idling. In that case, the shut-off valve is added to isolate the buffer tank 26 containing molecular hydrogen in the gaseous state and downstream therefrom from the rest of the system. This shut-off valve 200 is therefore closed only during the phase of starting the propulsion system 10. Although not described, other valves may be employed in the system 2 in order to control the mass flow rate and the fuel supply pressure during the starting sequence of starting the propulsion system 10.

Other components, such as temperature and/or pressure sensors, may be employed within the components of the system 2 or in the vicinity thereof, so as to allow control of the system 2, notably in accordance with the method of operation described hereinafter. For example a low-pressure pump temperature sensor, a pressure sensor arranged in the buffer tank, and a high-pressure pump temperature sensor may be installed in order to enable control of the system 2.

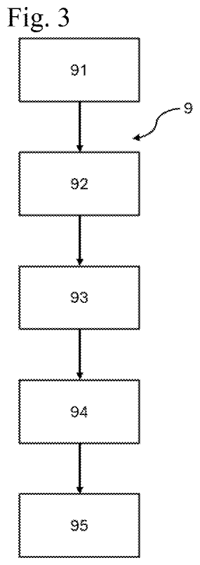

The invention also provides a method 9 of operation of the fuel supply system 2 described hereinabove. This method 9, illustrated in FIG. 3, thus comprises the steps of:
maintaining 91 the temperature of the low-pressure pump 22 at a temperature below 200 K;
cooling 92 the low-pressure pump 22 by circulating the liquid molecular hydrogen coming from the tank 21 through the low-pressure pump 22 until the temperature of the low-pressure pump 22 is below 30 K;
pressurizing 93 the fuel supply system 2 by injecting the liquid molecular hydrogen from the tank 21 into the system 2 until a pressure within the buffer tank 26 is greater than or equal to 0.1 MPa;
supplying 94 the combustion chamber 28 with molecular hydrogen during the starting and operation of said propulsion system 10; and,
cooling 95 the fuel supply system 2.

The temperature of the low-pressure pump 22 is maintained, during the step 91, at a temperature that is compatible with the starting of the low-pressure pump, which is to say between 20 K and 200 K.

The temperature of the low-pressure pump 22 is cooled, during the step 92, to a temperature below or equal to the saturation temperature for molecular hydrogen at the pressure of the fuel supply system 2 so as to reach an operating temperature compatible with the pumping of liquid molecular hydrogen, which is to say between 20 K and 30 K.

The pressure within the buffer tank 26 is increased, during the step 93, until the pressure obtained is compatible with the starting of the propulsion system or until the pressure obtained is equal to the conventional operating pressure, which is to say between 0.1 MPa and 5 MPa.

These steps in the operation of the fuel supply system 2 make it possible to optimize the consumption of molecular hydrogen for cooling the system 2 while at the same time ensuring optimal operation of the propulsion system 10.

More specifically, the step 91 of maintaining the temperature of the low-pressure pump 22 at a temperature below 200 K corresponds to the act of maintaining an initial state of the system 2, before it is activated, which is to say before any demand is placed upon it, by the propulsion system 10. In other words, the engine of the propulsion system 10 is at this stage not running. In this initial state, it is necessary for the low-pressure pump 22 always to be maintained at a sufficiently cold temperature enabling the generation of a mass flow rate for cooling. As a preference, the low-pressure pump 22 is sited close to the tank 21. Thus, the low-pressure pump 22 will be capable, when demand is placed upon it, of creating a mass flow rate for cooling with a low pressure increase at a moderate temperature where the molecular hydrogen will be able to vaporize upon contact with the surface of the low-pressure pump. As a preference, the low-pressure pump 22 is maintained at a temperature comprised between 30 K and 200 K.

To do that, significant insulation is employed between the low-pressure pump 22 and the ambient conditions (namely the environment external to the system 2) so as to lower the equilibrium temperature of the low-pressure pump 22 when there is no flow coming from the tank 21 and the tank 21 is full of liquid molecular hydrogen. If necessary (which is to say if the ambient conditions are favorable), the insulation between the tank 21 and the low-pressure pump 22 may be reduced.

During the step 91 of maintaining the temperature of the low-pressure pump 22, the high-pressure pump 23 is switched off and the flow-regulating valve 27 is closed. The temperature of the cryogenic tank 21 is below around 20 K (and this remains the case throughout the entire method 9).

During the step 92 of cooling the low-pressure pump 22, liquid molecular hydrogen therefore circulates from the tank 21 through the low-pressure pump 22 and then in the recirculation circuit 29. This step 92 is performed, as before, before the engine of the propulsion system 10 is started. The low-pressure pump 22 is cooled down to the operating temperature (which is to say a temperature below 30 K) as a result of the circulation of the liquid molecular hydrogen through the low-pressure pump 22. The liquid molecular hydrogen passing through the low-pressure pump 22 is then directed, as appropriate as described hereinafter, back to the tank 21 so as to optimize the consumption of molecular hydrogen and avoid discharging molecular hydrogen into the atmosphere. As in the previous step 91, the high-pressure pump 23 is switched off and the flow-regulating valve 27 is closed. At the end of the cooling step 92, the low-pressure pump 22 is at the desired temperature.

During the step 93 of pressurizing the fuel supply system 2, liquid molecular hydrogen is injected into the system 2 from the tank 21. Here, the high-pressure pump 23 is switched off and the flow-regulating valve 27 is still closed. This enables the buffer tank 26 to be filled and pressurized with pressurized gaseous molecular hydrogen. Specifically, during this step 93, although the temperature of the low-pressure pump is still below 30 K, the rest of the system 2 (with the obvious exception of the tank 21) is at a temperature above 300 K (which roughly corresponds to ambient temperature). The molecular hydrogen is therefore in its gaseous form, which enables the buffer tank 26 to be filled and pressurized. The low-pressure pump 22 is capable of pressurizing the system 2 to a pressure higher than that required for the starting phase (which means that starting can be performed, or a number of attempts at starting can be initiated).

It should be noted that the step 93 of pressurizing the system 2 comprises a sub-step of maintaining the pressure of the system at a pressure comprised between 0.1 MPa and 5 MPa and during which the flow-regulating valve 27 and the shut-off valve 200 (where used) are closed. This makes it possible to maintain the pressure in the buffer tank 26 until the next step 94 while keeping the low-pressure pump 22 active. Thus, between the pressurizing step 93 and the supply step 94, the method comprises a standby step, which is to say a time delay step, so that the pressure of the system 2 is maintained at a predetermined pressure for a predetermined length of time before the propulsion system is started. The low-pressure pump 22 is thus kept active so as to be ready for the starting of the propulsion system and so as to keep the already-cooled region cold. The high-pressure pump 23 is still deactivated.

During the step 94 of supplying the combustion chamber 28 with molecular hydrogen, the engine of the propulsion system 10 is started preferably using only the gaseous molecular hydrogen contained in the buffer tank 26. Next, the flow-regulating valve 27 is opened so as to allow the injection of molecular hydrogen and to stabilize the idling of the engine of the propulsion system 10. When the shut-off valve 200 is used, this is opened so that the mass flow rate from the tank 21 is re-established, as is the cooling of the system 2.

During the step 95 of cooling the fuel supply system, the circuit between the outlet 222 of the low-pressure pump 22 and the outlet 232 of the high-pressure pump 23, or the inlet 241 to the heat exchanger 24, is progressively cooled until the temperature is compatible with the starting of the high-pressure pump 23 and the use thereof for aircraft take-off. The gaseous hydrogen created by this cooling is consumed by the propulsion system at idle.

Thus, the molecular hydrogen present in the system 2 at the end of the step 94 is used to cool the rest of the fuel supply system 2, for example when the aircraft 1 is taxiing and before the take-off phase. Thus, all of the molecular hydrogen used for cooling is consumed by the engine of the propulsion system 10 and is considered as usable by the aircraft 1 for the taxiing phase.

It should be noted that the “ready for take-off” state is obtained when the high-pressure pump 23 is at the operating temperature and the pressure fluctuations are considered to be within the conditions for operation.

According to one optional configuration, the system 2 comprises an active cooling system for actively cooling the molecular hydrogen in the tank 21. In a variant, the tank 21 has significant thermal insulation that is configured to make it possible to maintain the temperature of the molecular hydrogen.

In a system 2 in the presence of molecular hydrogen, a “mass” reserve of the molecular hydrogen and a “cold” reserve of the molecular hydrogen are defined. The “mass” reserve corresponds to the quantity of molecular hydrogen available in the tank 21. The “cold” reserve corresponds to the temperature of the molecular hydrogen present in the tank 21. It is necessary to simultaneously manage the “mass” reserve and the “cold” reserve of the molecular hydrogen in the system 2.

In the system 2, the liquid molecular hydrogen contained in the tank 21 is used to cool the rest of the system 2 (low-pressure pump, high-pressure pump, pipework, valves, etc.). Thus, some of the “mass” and “cold” reserves of the molecular hydrogen are used to cool the rest of the system 2. In order to be introduced into the combustion chamber 28, the molecular hydrogen is thus heated and gasified.

According to a first embodiment, and in order to limit the amount of molecular hydrogen discharged into the atmosphere (and to preserve the “mass” reserve of the molecular hydrogen, which is to say a certain quantity of molecular hydrogen in the system 2), during the steps of cooling 92 the low-pressure pump 22 and of cooling 95 the system 2, the molecular hydrogen circulating from the tank 21 and passing through the low-pressure pump 22 next circulates in the recirculation circuit 29 in order to return to the tank 21, if the temperature of the molecular hydrogen leaving the low-pressure pump 22 is below a maximum temperature, for example below 300 K, preferably below 150 K, even more preferably below 30 K.

In the recirculation circuit 29, the temperature of the molecular hydrogen is compatible with the molecular hydrogen being reinjected into the tank 21, which is to say below 300 K, for example at around 150 K. More specifically, the molecular hydrogen is at a temperature below the maximum temperature at which the tank 21 can accept it for return thereto, which is to say below 300 K, and preferably below 150 K.

In this way, the system 2 allows the molecular hydrogen used for cooling the low-pressure pump 22 to be recirculated (which is to say it allows the heated molecular hydrogen to be reinjected into the tank 21), provided that the molecular hydrogen is not too hot. Specifically, this makes it possible to optimize the consumption of molecular hydrogen and to minimize the amount of molecular hydrogen discharged into the atmosphere. This embodiment advantageously makes it possible to favor the “mass” reserve of the molecular hydrogen, rather than its “cold” reserve.

According to a second other embodiment, in order to optimize the consumption of molecular hydrogen during cooling, during the steps of cooling 92 the low-pressure pump 22 and of cooling 95 the system 2, the molecular hydrogen circulating from the tank 21 and passing through the low-pressure pump 22 next circulates in a venting circuit that vents the tank 21 if the temperature of the molecular hydrogen leaving the low-pressure pump 22 is above a minimum temperature, for example above 30 K, preferably above 150 K, and even more preferably above 300 K.

In the venting circuit for venting the tank 21, the temperature of the molecular hydrogen is generally above 30 K, for example at around 150 K. More specifically, the molecular hydrogen is at a temperature above the maximum temperature at which the tank 21 can accept it for reinjection (the tank 21 being able to take reinjected molecular hydrogen at between 30 K and 300 K).

In this way, the system 2 makes it possible to discharge molecular hydrogen that is too hot, thereby making it possible to avoid excessively diminishing the “cold” reserve of the molecular hydrogen. In addition, this also makes it possible to optimize the consumption of molecular hydrogen. This embodiment advantageously makes it possible to favor the “cold” reserve of the molecular hydrogen (temperature of the molecular hydrogen in the tank 21), rather than its “mass” reserve. Specifically, if the molecular hydrogen is too hot, the “cold” reserve of the molecular hydrogen is preserved by discharging the heated molecular hydrogen towards a treatment system then into the atmosphere (via the venting circuit).

According to a third embodiment, and in order to optimize the consumption of molecular hydrogen during cooling, and therefore so as to limit the amount of molecular hydrogen discharged into the atmosphere, during the steps of cooling 92 the low-pressure pump 22 and of cooling 95 the system 2, one fraction of the molecular hydrogen circulating from the tank 21 and passing through the low-pressure pump 22 next circulates:
in the recirculation circuit 29 in order to return to the tank 21, if the temperature of the molecular hydrogen leaving the low-pressure pump 22 is below a predetermined threshold temperature, and another fraction of the molecular hydrogen circulating from the tank 21 and passing through the low-pressure pump 22 next circulates:
in a venting circuit that vents the tank 21 if the temperature of the molecular hydrogen leaving the low-pressure pump 22 is above the predetermined threshold temperature.

The predetermined threshold temperature may be equal to 30 K, or preferably equal to 150 K.

Thus, one fraction of the molecular hydrogen returns to the tank 21 (preserving the “mass” reserve of the molecular hydrogen) and another fraction of the molecular hydrogen is discharged into the atmosphere (preserving the “cold” reserve of the molecular hydrogen).

In this way, the system 2 allows some of the molecular hydrogen used for cooling the low-pressure pump 22 to be recirculated, provided that the molecular hydrogen is not too hot. Specifically, this makes it possible to optimize the consumption of molecular hydrogen and to minimize the amount of molecular hydrogen discharged into the atmosphere.

Depending on the requirements of the system 2, either the use of the “mass” reserve of the molecular hydrogen (the warm molecular hydrogen is reinjected into the tank 21, thereby heating it somewhat) or the use of the “cold” reserve of the molecular hydrogen (the molecular hydrogen is discharged into the atmosphere) is optimized. The temperature of the molecular hydrogen after use serves as a criterion for this optimization.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for supplying fuel to a propulsion system for an aircraft, the system comprising:
a cryogenic tank containing a fuel, wherein the fuel is liquid molecular hydrogen and the cryogenic tank comprises a first inlet orifice and a first outlet orifice;
a low-pressure pump situated downstream of the cryogenic tank and comprising a second inlet orifice fluidically connected to the first outlet orifice of the cryogenic tank and a second outlet orifice;
a high-pressure pump situated downstream of the low-pressure pump and comprising a third inlet orifice fluidically connected to the second outlet orifice of the low-pressure pump and a third outlet orifice;
a heat exchanger situated downstream of the high-pressure pump and comprising a fourth inlet orifice fluidically connected to the third outlet orifice of the high-pressure pump and a fourth outlet orifice;
a nonreturn valve situated downstream of the heat exchanger and comprising a fifth inlet orifice fluidically connected to the fourth outlet orifice of the heat exchanger and a fifth outlet orifice;
a buffer tank configured to contain gaseous molecular hydrogen, the buffer tank situated downstream of the nonreturn valve and comprising a sixth inlet orifice fluidically connected to the fifth outlet orifice of the nonreturn valve and a sixth outlet orifice;
a flow-regulating valve situated downstream of the buffer tank and comprising a seventh inlet orifice fluidically connected to the sixth outlet orifice of the buffer tank and a seventh outlet orifice;
a combustion chamber situated downstream of the flow-regulating valve and comprising an eighth inlet orifice fluidically connected to the seventh outlet orifice of the flow-regulating valve; and
a recirculation circuit comprising a ninth inlet orifice fluidically connected to the second outlet orifice of the low-pressure pump and a ninth outlet orifice fluidically connected to the first inlet orifice of the cryogenic tank.

2. The system according to claim 1, further comprising:
a shut-off valve situated between the heat exchanger and the nonreturn valve and comprising a tenth inlet orifice fluidically connected to the fourth outlet orifice of the heat exchanger and a tenth outlet orifice fluidically connected to the fifth inlet orifice of the nonreturn valve.

3. The system according to claim 1, further comprising:
at least one temperature sensor, at least one pressure sensor, or both.

4. A propulsion system for an aircraft comprising:
the system according to claim 1.

5. An aircraft comprising:
at least one propulsion system according to claim 4.

6. A method of operation of the system according to claim 1, wherein the method comprises the steps of:
maintaining a temperature of the low-pressure pump below 200 K;
cooling the low-pressure pump by circulating the liquid molecular hydrogen coming from the cryogenic tank through the low-pressure pump until the temperature of the low-pressure pump is below 30 K;
pressurizing the system by injecting the liquid molecular hydrogen from the cryogenic tank into the system until a pressure within the buffer tank is greater than or equal to 0.1 MPa;
supplying the combustion chamber with hydrogen during a starting and an operation of the propulsion system; and,
cooling the system.

7. The method according to claim 6, wherein during the steps of cooling the low-pressure pump and cooling the system, hydrogen circulating from the cryogenic tank and passing through the low-pressure pump next circulates in the recirculation circuit in order to return to the cryogenic tank when a temperature of hydrogen leaving the low-pressure pump is below 150 K.

8. The method according to claim 6, wherein during the steps of cooling the low-pressure pump and cooling the system, hydrogen circulating from the cryogenic tank and passing through the low-pressure pump next circulates in a venting circuit that vents the cryogenic tank when a temperature of hydrogen leaving the low-pressure pump is above 30 K.

9. The method according to claim 6, wherein during the steps of cooling the low-pressure pump and cooling the system, a first portion of hydrogen circulating from the cryogenic tank and passing through the low-pressure pump next circulates in the recirculation circuit in order to return to the cryogenic tank when a temperature of hydrogen leaving the low-pressure pump is below 150 K, and a second fraction of hydrogen circulating from the cryogenic tank and passing through the low-pressure pump next circulates in a venting circuit that vents the cryogenic tank when the temperature of hydrogen leaving the low-pressure pump is above 150 K.

10. The method according to claim 6, wherein during the steps of cooling the low-pressure pump and cooling the system, a first portion of hydrogen circulating from the cryogenic tank and passing through the low-pressure pump next circulates in the recirculation circuit in order to return to the cryogenic tank when a temperature of hydrogen leaving the low-pressure pump is below 30 K, and a second portion of hydrogen circulating from the cryogenic tank and passing through the low-pressure pump next circulates in a venting circuit that vents the cryogenic tank when the temperature of hydrogen leaving the low-pressure pump is above 30 K.

11. The method according to claim 6, wherein during the steps of pressurizing the system comprises a sub-step of maintaining a pressure of the system at a pressure between 0.1 MPa and 5 MPa and during which the flow-regulating valve and a shut-off valve, situated between the heat exchanger and the nonreturn valve, are closed.
